(19) United States
(12) Patent Application Publication
(10) Pub. No.: US 2025/0188222 A1
(43) Pub. Date: Jun. 12, 2025

(54) SYNTHESIS OF PHOSPHONATED POLYMER RESINS FOR THE EXTRACTION OF RARE-EARTH ELEMENTS

(71) Applicant: VIRGINIA TECH INTELLECTUAL PROPERTIES, INC., Blacksburg, VA (US)

(72) Inventors: William Ryan Archer, Blacksburg, VA (US); Michael D. Schulz, Christiansburg, VA (US)

(21) Appl. No.: 18/841,084

(22) PCT Filed: Feb. 23, 2023
(86) PCT No.: PCT/US2023/013711

§ 371 Date: Aug. 23, 2024

Related U.S. Application Data
(60) Provisional application No. 63/313,133, filed on Feb. 23, 2022.

(51) Int. Cl. C08G 73/02; C22B 59/00

(52) U.S. Cl. CPC C08G 73/0246; C22B 59/00

(57) ABSTRACT

In one aspect, the disclosure relates to the use of poly(diethylenepolyamine) derivatives for the extraction of metals, in particular rare-earth metals. In another aspect the disclosure relates to articles and methods for extracting rare-earth metals.

### CROSS-REFERENCE TO RELATED APPLICATIONS

This Application claims priority to and the benefit of U.S. Provisional Application No. 63/313,133 entitled “SYNTHESIS OF PHOSPHONATED POLYMER RESINS FOR THE EXTRACTION OF RARE-EAR^{†}H ELEMENTS”, filed Feb. 23, 2022, which is incorporated herein by reference in its entirety.

### BACKGROUND

Rare-earth elements (REEs) enable many modern technologies including catalysts, cell phones, hard drives, magnets, and a host of clean energy technologies, resulting in ever-increasing demand for these metals. Consequently, developing effective technologies for extracting and separating REEs remains a high priority for technology manufacturing and clean energy. The rock around coal seams and the coal mining process contains large amounts of REE-rich aqueous drainage, which could be a source of these critical elements. Similarly, coal-ash produced by power generation retains REEs originally present in the coal, and could form a commercial source of these elements. Thus, it may be important to develop efficient methods to extract REEs where concentrations may be as low as 1-100 ppm, or less.

### SUMMARY

In accordance with the purpose(s) of the disclosure, as embodied and broadly described herein, the disclosure, in one aspect, relates to an REE-chelating resin having phosphonate groups. This material design enables higher REE capacity relative to surface-functionalized solid-phase extractants and uses covalently attached ligands that impart greater chemical stability of the resin so the resin may be used multiple times.

In some aspects, a network polymer is provided having a unit of formula (I):

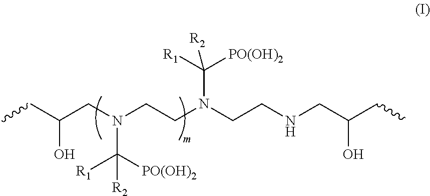

wherein m is an integer from 1 to 4; R₁ and R₂ are independently H, D, C₁-C₆ alkyl, or C₆-C₁₂ aryl; or a salt thereof.

In some aspects, a polymer is providing containing the free bases and/or acid addition salts of a cross-linked copolymerization product of (a) a polyethylenepolyamine containing from about two to about 10 ethylene units and (b) a second member selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane, wherein the product contains by weight from about 10 percent to about 50 percent of said second member; and wherein the polymer comprises a multiplicity of —C(R₁R₂P(O)(OH)₂ moieties, or salts thereof, wherein the carbon atoms of the —C(R₁R₂P(O)(OH)₂ moieties are covalently bonded to nitrogens, wherein R₁ and R₂ are independently H, C₁-C₆ alkyl, or C₆-C₁₂ aryl.

In various aspects, a method of isolating an element is provided, the method including contacting a liquid composition containing the element with a polymer described herein to form an element-polymer adduct. The element can be a rare earth element (REE). The element can include one or more of those selected from the group consisting of Lithium, Lead, Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Lutetium, Hafnium, Tantalum, Tungsten, Rhenium, Osmium, Iridium, Platinum, Gold, Mercury, Lanthanum, Cerium, Praseodymium, Neodymium, Promethium, Samarium, Europium, Gadolinium, Terbium, Dysprosium, Holmium, Erbium, Thulium, Ytterbium, Lutetium, Lawrencium, Rutherfordium, Dubnium, Seaborgium, Bohrium, Hassium, Meitnerium, Darmstadtium, Roentgenium, Copernicium, Actinium, Thorium, Protactinium, Uranium, Neptunium, Plutonium, Americium, Curium, Berkelium, Californium, Einsteinium, Fermium, Mendelevium, and Nobelium.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows the effect of pH on rare earth element sorption of netPoly(DETA)-v-ECH MP according to the present description.

FIG. 2 shows the mol fraction of rare earth elements captured in the first flow fraction according to the present description.

FIG. 3 shows a correlation between percent REE capture, REE ionic radii, and calculated distribution coefficient according to the present description.

FIG. 4 shows a correlation between percent capture, REE ionic radii, and calculated distribution coefficient.

FIGS. 5A-5C show three scanning electron microscopy (SEM) images. FIG. 5A shows a SEM image of netPoly(DETA)-ν-ECH; FIG. 5B shows a SEM image of netPoly(DETA)-ν-ECH MP; and FIG. 5C shows a SEM image of netPoly(DETA)-ν-ECH MP after REE capture according to the present description.

FIG. 6 shows a comparison of K_{a(ITC)} and K_{d(Flow)} of the REE series in order of increasing ionic radi according to the present description.

FIG. 7 shows the amounts of REE ions extracted from coal ash sample in pg metal ion per g resin, and initial concentrations of each metal ion.

The advantages of the disclosure will be realized and attained by means of the elements and combinations particularly pointed out in the appended claims, It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications and patents mentioned or cited herein are incorporated herein by reference to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited, including any lexicographical definition in any patent or patent application in the priority claim, that is not also expressly repeated in the instant specification should not be treated as such and should not be read as defining any terms appearing in the accompanying claims. The publications and patents discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “having,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used herein, the term “and/or” includes all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Reference to “a/an” chemical compound, protein, and antibody each refers to one or more molecules of the chemical compound, protein, and antibody rather than being limited to a single molecule of the chemical compound, protein, and antibody. Furthermore, the one or more molecules may or may not be identical, so long as they fall under the category of the chemical compound, protein, and antibody. Thus, for example, “an” antibody is interpreted to include one or more antibody molecules of the antibody, where the antibody molecules may or may not be identical (e.g., different isotypes and/or different antigen binding sites as may be found in a polyclonal antibody).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as Nell as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “contacting” as used herein refers to bringing a disclosed analyte, compound, chemical, or material in proximity to another disclosed analyte, compound, chemical, or material as indicated by the context. For example, an analyte contacting an antibody refers to the analyte being in proximity to the antibody by the analyte interacting and binding to the antibody via ionic, dipolar and/or van der Waals interactions. In some instances, contacting can comprise both physical and chemical interactions between the indicated components. It is to be understood that chemical interactions can comprise a combination of covalent and non-covalent interactions, including one or more of ionic, dipolar, van der Waals interactions, and the like.

The term “contacting” as used herein refers to bringing a disclosed compound or pharmaceutical composition in proximity to a cell, a target protein, or other biological entity together in such a manner that the disclosed compound or pharmaceutical composition can affect the activity of the a cell, target protein, or other biological entity, either directly; i.e., by interacting with the cell, target protein, or other biological entity itself, or indirectly; i.e., by interacting with another molecule, co-factor, factor, or protein on which the activity of the cell, target protein, or other biological entity itself is dependent.

As used herein, the terms “optional” or “optionally” means that the subsequently described event or circumstance can or cannot occur, and that the description includes instances where said event or circumstance occurs and instances where it does not.

Unless otherwise specified, experiments and values reported herein are at room temperature (about 293 K or about 20° C.) and pressure (1 atmosphere), and temperatures are at 1 atmosphere uness otherwise indicated.

Throughout the specification “alkyl” is generally used to refer to both unsubstituted alkyl groups and substituted alkyl groups. Suitable monovalent substituents on a substitutable carbon atom of an substituted alkyl group are independently halogen; —(CH₂)₀₋₄R^{o}; —(CH₂)₀₋₄OR^{o}; —O(CH₂)₀₋₄R^{o}, —O—(CH₂)₀₋₄C(O)OR^{o}; —(CH₂)₀₋₄CH(OR^{o})₂; —(CH₂)₀₋₄SR^{o}; —(CH₂)₀₋₄Ph, which may be substituted with R^{o}; —(CH₂)₀₋₄O(CH₂)₀₋₁Ph which may be substituted with R^{o}; —CH═CHPh, which may be substituted with R⁰; —(CH₂)₀₋₄O(CH₂)₀₋₁-pyridyl which may be substituted with R^{o}; —NO₂; —CN; —N₃; —(CH₂)₀₋₄N(R^{o})₂; —(CH₂)₀₋₄N(R^{o})C(O)R^{o}; —N(R^{o})C(S)R^{o}—(CH₂)₀₋₄N(R^{o})C(O)NR^{o}₂; —N(R^{o})C(S)NR^{o}₂, —(CH₂)₀₋₄N(R^{o})C(O)OR^{o}; —N(R^{o})N(R^{o})C(O)R^{o}; —N((R^{o})N(R^{o})C(O)NR^{o}₂; —N(R^{o})N(R^{o})C(O)OR^{o}; —(CH₂)₀₋₄C(O)R^{o}; —C(S)R^{o}; —(CH₂)₀₋₄C(O)OR^{o}; —(CH₂)₀₋₄C(O)SR^{o}; —(CH₂)₀₋₄C(O)OSiR^{o}₃; —(CH₂)₀₋₄OC(O)R^{o}; —OC(O)(CH₂)₀₋₄SR—, SC(S)SR^{o}; —(CH₂)₀₋₄SC(O)R^{o}; —(CH₂)₀₋₄C(O)NR^{o}₂; —C(S)NR^{o}₂; —C(S)SR^{o}; —(CH₂)₀₋₄OC(O)NR^{o}₂; —C(O)N(0R^{o})R^{o}; —C(O)C(O)R^{o}—C(O)CH₂C(O)R; —C(NOR^{o})R^{o}; —(CH₂)₀₋₄SSR^{o}; —(CH₂)₀₋₄S(O)₂R^{o}, —(CH₂)₀₋₄S(Q)₂OR^{o}; —(CH₂)₀₋₄OS(0)₂R^{o}; —S(O)₂NR^{o}₂; —(CH₂)₀₋₄S(O)R^{o}; —N(R^{o})S(O)₂NR^{o}₂; —N(R^{o})S(O)₂R^{o}; —N(OR^{o})R^{o}; —C(NH)NR^{o}₂; —P(O)₂R^{o}; —P(O)R^{o}₂; —OP(O)R^{o}₂; —OP(O)(OR^{o})₂; SiR^{o}₃; —(C₁₋₄ straight or branched alkylene)O-N(R^{o})₂; or —(C₁₋₄ straight or branched alkylene)C(O)O—N(R^{o})₂, wherein each R^{o} may be substituted as defined below and is independently hydrogen, C₁-6 aliphatic, —CH₂Ph, —O(CH₂)₀₋₁Ph, —OH₂-(5-6 membered heteroaryl ring), or a 5-6-membered saturated, partially unsaturated, or aryl ring having 0-4 heteroatoms independently selected from nitrogen, oxygen, or sulfur, or, notwithstanding the definition above, two independent occurrences of R^{o}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{o} (or the ring formed by taking two independent occurrences of R^{o} together with their intervening atoms), are independently halogen, —(CH₂)₀₋₂R^{•}, —(haloR^{•}), —(CH₂)₀₋₂OH, —(CH₂)₀₋₂OR^{•}, —(CH₂)₀₋₂CH(OR*)₂; —O(haloR^{•}), —CN, —N₃, —(CH₂)₀₋₂C(O)R^{•}, —(CH₂)₀₋₂C(O)OH, —(CH₂)₀₋₂C(O)OR*, —(CH₂)₀₋₂SR′, —(CH₂)₀₋₂SH, —(CH₂)₀₋₂NH₂, —(CH₂)₀₋₂NHR^{•}, —(CH₂)₀₋₂NR^{•}₂, —NO₂, —SiR^{•}₃, —OSiR^{•}₃, —C(O)SR^{•}, —(C₁₋₄ straight or branched alkylene)C(O)OR*, or —SSR^{•} wherein each R^{•} is unsubstituted or where preceded by “halo” is substituted only with one or more halogens, and is independently selected from C₁-4 aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{o} include ═O and ═S.

Suitable divalent substituents on a saturated carbon atom of an “optionally substituted” group include the following: ═O, ═S, ═NNR^{*}₂, ═NNHC(O)R*, ═NNHC(O)OR*, ═NNHS(O)₂R*, =NR*, =NOR*, —O(C(R^{*}₂))₂₋₃O—, or —S(C(R^{*}₂))₂₋₃—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR^{*}₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{•}, —(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R* is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR†₂, —C(S)NR^{†}₂, —C(NH)NR^{•}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{•}, —(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond.

For example, biaryl to two aryl groups that are bound together via a fused ring structure, as in naphthalene, or are attached via one or more carbon-carbon bonds, as in biphenyl.

### Network Polymers and Devices and Kits Containing Network Polymers

The present disclosure is directed to network polymers, and in particular to network polymers capable of extracting rare earth elements even at very low concentrations of the rare earth element.

In various aspects, the network polymers include crosslinked polyethylenepolyamine based resins that have been functionalized with phosphonate groups, in particular phosphonate groups throughout the bulk of the network polymer. Crosslinked polyethylenepolyamine resins are a type of ion exchange resin that contain multiple amine groups, which are capable of binding to positively charged metal ions. The amine groups are typically derived from amines such as ethylene diamine or diethylenetriamine, and they are crosslinked with a crosslinking agent such as epichlorohydrin.

The crosslinking of diamine resins improves their stability and mechanical strength, making them suitable for use in various industrial applications, such as metal recovery and water treatment. Crosslinked polyethylenepolyamine resins can be made in different forms, such as beads, granules, or powder, and can be packed into columns or used in batch mode.

Crosslinked polyethylenepolyamine resins have several advantages over other types of ion exchange resins, such as their high mechanical strength, chemical stability, and selectivity for metal ions. They are also compatible with a wide range of sample matrices, including aqueous solutions and industrial effluents.

In some aspects, a network polymer is provided having a unit of formula (1):

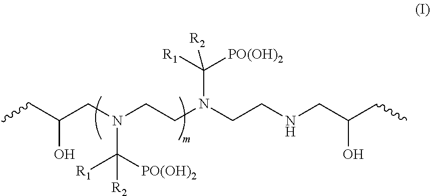

wherein m is an integer from 1 to 4; R₁ and R₂ are independently H, D, C₁-C₆ alkyl, or C₆-C₁₂ aryl; or a salt thereof.

In some aspects, a polymer is providing containing the free bases and/or acid addition salts of a cross-linked copolymerization product of (a) a polyethylenepolyamine containing from about two to about 10 ethylene units and (b) a second member selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane, wherein the product contains by weight from about 10 percent to about 50 percent of said second member; and wherein the polymer comprises a multiplicity of —C(R₁R₂P(O)(OH)₂ moieties, or salts thereof, wherein the carbon atoms of the —C(R₁R₂P(O)(OH)₂ moieties are covalently bonded to nitrogens, wherein R₁ and R₂ are independently H, C₁-C₆ alkyl, or C₆-C₁₂ aryl.

In some aspects, the network polymer may be in granular or powdered form. For example, the network polymer may be milled to any particle size or particle distribution known to the person of ordinary skill in the art. In an embodiment, the grain size of a network polymer particle may be from about 0.001 mm to about 100 mm, or from about 0.001 mm to about 10 mm, or from about 0.001 mm to about 1 mm, or from about 0.001 mm to about 0.1 mm, or from about 0.001 mm to about 0.01 mm.

In another aspect the particles may have a specific surface area of from about 50 m²/g to about 3000 m²/g, or from about 50 m²/g to about 2000 m²/g, or from about 50 m²/g to about 1000 m²/g, or from about 50 m²/g to about 900 m²/g, or from about 100 m²/g to about 900 m²/g, or from 200 m²/g to about 900 m²/g, or from about 300 m²/g to about 900 m²/g, or from about 400 m²/g to about 900 m²/g, or from about 500 m²/g to about 900 m²/g.

In another aspect, the disclosure includes a composition including the network polymer. In an embodiment, the composition includes the network polymer and an acceptable excipient or support. For example, the composition may comprise the network polymer in admixture with an acceptable excipient such that the network polymer includes (in weight percent (%)) about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 percent by weight of the composition. In the forgoing percentages of the network polymer in the composition, the composition may comprise a range of percentages from one number to another. For example, the composition may comprise from about 20% to about 61% of the network polymer in the composition.

In an aspect, the disclosure includes a device including the network polymer. Suitable devices can include functionalized columns containing the network polymer, membranes containing the network polymer, microfluidic devices containing the network polymer, and the like. These devices can be used for selective metal extraction from complex samples, such as industrial waste, contaminated water, or biological fluids.

In some aspects, separation columns containing the network polymer are provided. The column can be packed with any amount of the network polymer suitable for the given column dimensions and application. The packing of the column should typically be homogeneous and free of voids to ensure efficient separation. The column can be packed using a slurry method or packed under pressure. The diameter and length of the column can be adjusted depending on the sample volume and the required separation efficiency.

The amount of network polymer packed in a separation column can vary depending on several factors, including the type of network polymer used, the size of the column, and the sample volume. Typically, the amount of network polymer packed in a separation column is determined by the capacity of the network polymer to bind to the specific metal ions of interest, as well as the physical characteristics of the column.

The amount of network polymer packed in a separation column is typically expressed in terms of bed volume, which is the volume of the column occupied by the polymer. Bed volume is calculated by multiplying the column length by the internal diameter of the column, and then multiplying that result by the packing density of the polymer.

For laboratory-scale separation columns, the bed volumes can range from a few milliliters to several hundred milliliters e.g. from about 10 mL to about 900 mL. In some cases, smaller volumes can be used, particularly when the sample volume is limited or the concentration of the metal ions is high. For industrial-scale separation columns, the bed volumes can be much larger, ranging from 100 L to about 800,000 L, from about 100 L to about 10,000 L, from about 10,000 L to about 100,000 L, or from about 100,000 L to about 800,000 L. The size of the column can be optimized based on the volume of the sample and the desired throughput.

The packing density of the network polymer refers to the ratio of the mass of the polymer packed in the column to the volume of the column occupied by the polymer. The packing density can vary depending on the size and shape of the polymer particles, as well as the packing method used. Typically, the packing density of the network polymer ranges from 0.3 to 1.2 g/mL e.g., about 0.5 g/mL to about 1.0 g/mL or from about 0.5 g/mL to about 0.8 g/mL.

The amount of network polymer packed in a separation column can also be expressed in terms of the amount of network polymer per unit weight or volume of sample. The amount of network polymer required for optimal separation efficiency depends on the metal ions of interest, the sample matrix, and the required detection limit.

Overall, the amount of network polymer packed in a separation column can impace the efficiency and selectivity of the separation. Optimization of the amount of network polymer packed in the column can help to achieve high purity and yield of the metal ions of interest.

The disclosure includes a kit including the network polymer. A kit for isolating rare earth elements can include a network polymer and a column e.g., a pre-packed column containing the network polymer, and a set of solutions for metal elution and regeneration of the column. The column can be made of glass or plastic and can be designed to be compatible with common laboratory instruments.

The solution or solutions for eluting the metal are also carefully chosen to efficiently elute the metal ions from the column. This solution can be acidic or basic. After elution, the column is regenerated using a separate regenerating solution that removes any remaining metal ions from the network polymer, restoring it to its original state. In some instances, the eluting solution has a pH of about 5, or of about 4.5 to about 5.5, or of about 4 to about 6. In some instances, the regenerating solution has a pH of about 2, or about 1.5 to about 2.5, or about 1 to about 3, or about 0.5 to about 2.5. The kit can also include buffers, standards, and sample preparation materials to help users prepare their samples and analyze their results. The instructions for use may provide guidelines for sample preparation, column loading, elution, and regeneration.

### Methods of Making Network Polymers

Network polymers can be synthesized by crosslinking polyethylenepolyamines with a crosslinking agent, such as epichlorohydrin or others described herein.

Polyethylenepolyamines, such as ethylenediamine and diethylenetriamine, have multiple amine groups that react with the epoxide groups of epichlorohydrin to form a three-dimensional network.

The synthesis of network polymers involves several steps, including the mixing of the polyethylenepolyamine and the crosslinking agent, sometimes followed by the addition of a catalyst to initiate the crosslinking reaction. The reaction is typically carried out in a solvent, such as water or ethanol, at elevated temperatures to promote the formation of the crosslinked network.

In some aspects, a method of preparing a polymer is provided including (i) reacting a polyethylenepolyamine containing from about two to about 10 ethylene units and a compound selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane to produce an intermediate; and (ii) reacting the intermediate with a compound of formula R₁R₂CO, or an acetal or hemiacetal thereof, phosphonic acid and/or phosphoric acid, wherein R₁ and R₂ are independently H, C₁-C₆ alkyl, or C₆-C₁₂ aryl. The resulting network polymer can therefore be the free bases and/or acid addition salts of a cross-linked copolymerization product of (a) a polyethylenepolyamine containing from about two to about 10 ethylene units and (b) a second member selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane, wherein the product contains by weight from about 10 percent to about 50 percent of said second member; and wherein the polymer comprises a multiplicity of —C(R₁R₂P(O)(OH)₂ moieties, or salts thereof, wherein the carbon atoms of the —C(R₁R₂P(O)(OH)₂ moieties are covalently bonded to nitrogens.

The crosslinking reaction between the polyethylenepolyamine and the crosslinking agent such as epichlorohydrin can be controlled by varying the molar ratio of the two reagents, as well as the reaction time and temperature. Higher molar ratios of crosslinking agent to polyethylenepolyamine result in a higher degree of crosslinking and a more rigid network structure. The resulting network polymer can have a wide range of properties, depending on the specific polyethylenepolyamine and crosslinking agent used, as well as the reaction conditions.

Overall, the synthesis of network polymers from polyethylenepolyamines and crosslinking agents, such as epichlorohydrin, is a versatile and effective method for the production of materials with various properties and applications.

### Methods of Using Network Polymers and Devices and Kits Containing Network Polymers

Polymer-assisted methods for rare earth element (REE) extraction have gained attention in recent years due to their potential to improve selectivity, reduce the environmental impact, and decrease the cost of the extraction process. The basic principle of polymer-assisted extraction is to use a polymer that is selective for the REE of interest and can form a complex with it. The polymer-bound REE can then be separated from the solution using a variety of methods, such as precipitation, membrane filtration, or solvent extraction. In various aspects, a network polymer described herein is used to extract one or more rare earth elements from a liquid using a precipitation, membrane filtration, solvent extraction, or combination thereof.

In some aspects, network polymers are used in a polymer-enhanced solvent extraction (PESE), where a network polymer is added to the solvent extraction process to increase the selectivity and efficiency of the separation. In PESE, the network polymer selectively binds to the REE of interest, which can then be extracted from the solution using a conventional solvent. The polymer-enhanced solvent mixture is then separated from the remaining solution using a liquid-liquid extraction process.

In yet other aspects, a network polymer is used in a method of polymer-enhanced ultrafiltration (PEUF), where a network polymer is added to the solution containing the REE of interest, and the mixture is passed through a membrane filter. The network polymer selectively binds to the REE, and the polymer-bound REE is retained on the membrane, while the remaining solution is allowed to pass through. The polymer-bound REE can then be eluted from the membrane using an appropriate solvent.

In some aspects, network polymers are used in polymer-supported liquid membrane (PSLM) which utilize a network polymer to extract REEs. In PSLM, the network polymer is coated onto a porous support material and placed in contact with the solution containing the REE. The network polymer selectively binds to the REE, and the complex is transported across the porous support material using a liquid membrane. The polymer-bound REE can then be recovered from the membrane using an appropriate solvent.

Overall, polymer-assisted methods for REE extraction offer several advantages over conventional methods, including improved selectivity, reduced environmental impact, and lower costs. However, further research is required to optimize these methods and improve their efficiency and applicability to a wide range of REE sources.

In an aspect, the network polymer may be used to separate metal ions from an aqueous mixture at a pH from about 1, about 2, about 3, about 4, about 5, about 6, about 7, about 8, about 9, about 10, about 11, about 12, about 13, or about 14 as discussed below. In the forgoing pH values of the aqueous mixture, the pH may comprise a range pH values from one number to another. For example, the composition may comprise from about 2 to about 6 for the aqueous mixture.

Such a process may provide a metal polymer adduct. The metal polymer adduct may then be treated with a highly acidic aqueous solution (e.g., from 0 to 2 pH) to release metal ions from the metal polymer adduct. In another aspect, the network polymer may be treated with base, or another agent, to provide the network polymer with active binding chelates, e.g., monodeprotonated or dideprotonated phosphonate moieties.

In an aspect, a substantial percentage of the —P(O)(OH)₂ moieties of the network polymer are monodeprotonated, to provide —P(O)(O⁻¹)(OH) moieties. For example the network polymer has about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, or about 100 percent of the —P(O)(OH)₂ moieties of the network polymer are monodeprotonated, to provide —P(O)(O⁻¹)(OH) moieties. In the forgoing percentages the percent monodeprotonation may comprise a range of percentages from one number to another. For example, the composition may comprise from about 20% to about 61% of monodeprotonated phosphonate moieties (—P(O)(O⁻¹)(OH)).

In an aspect, the polymer treated with the highly acidic aqueous solution may be regenerated by treatment of the polymer with a basic to neutral solution such that a majority of the —P(O)(OH)₂ groups are monodeprotonated to provide —P(O)(O′)(OH) moieties.

### Aspects of the Disclosure

The disclosure will be better understood by reading the following numbered aspects, which should not be confused with the claims. In some instances, one or more aspects may be combined or combined with aspects described elsewhere in the disclosure or aspects from the examples without deviating from the invention. The following listing of exemplary aspects supports and is supported by the disclosure provided.

Aspect 1. A network polymer including a unit of formula (I):

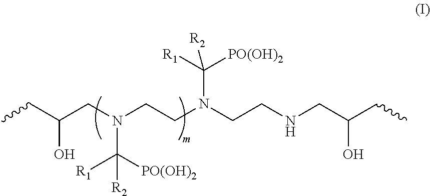

wherein m is an integer from 1 to 4;
R₁ and R₂ are independently H, D, C₁-C_{F} alkyl, or C₆-C₁₂ aryl,;
or a salt thereof.

Aspect 2. The polymer of Aspect 1 wherein m is 1.

Aspect 3. The polymer of Aspect 2 wherein m is 2.

Aspect 4. The polymer of Aspect 3 wherein m is 3.

Aspect 5. The polymer of any one of Aspects 1-4 wherein R₁ is H.

Aspect 6. The polymer of any one of Aspects 1-5 wherein R₂ is H.

Aspect 7. The polymer of any one of Aspects 1-6 wherein R₁ and R₂ are H.

Aspect 8. The polymer of any one of Aspects 1-7 wherein R₁ is CH₃.

Aspect 9. The polymer of any one of Aspects 1-8 wherein R₂ is CH₃.

Aspect 10. The polymer of any one of Aspects 1-9 wherein R₁ is CH₂CH₃.

Aspect 11. The polymer of any one of Aspects 1-10 wherein R₂ is CH₂CH₃.

Aspect 12. The polymer of any one of Aspects 1-11 wherein the unit has a net −1 charge.

Aspect 13. The polymer of any one of Aspects 1-11 wherein the unit has a net −2 charge at pH 7.

Aspect 14. The polymer of any one of Aspects 1-11 wherein the unit has a net −3 charge at pH 7.

Aspect 15. The polymer of any one of Aspects 1-11 wherein the unit has a net −4 charge at pH 7.

Aspect 16. The polymer of any one of Aspects 1-11 wherein the unit has a net +1 charge at pH 7.

Aspect 17. A method of isolating an element selected from the group consisting of Lithium, Lead, Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Lutetium, Hafnium, Tantalum, Tungsten, Rhenium, Osmium, Iridium, Platinum, Gold, Mercury, Lanthanum, Cerium, Praseodymium, Neodymium, Promethium, Samarium, Europium, Gadolinium, Terbium, Dysprosium, Holmium, Erbium, Thulium, Ytterbium, Lutetium. Lawrencium, Rutherfordium, Dubnium, Seaborgium, Bohrium, Hassium, Meitnerium, Darmstadtium, Roentgenium, Copernicium, Actinium, Thorium, Protactinium, Uranium, Neptunium, Plutonium, Americium, Curium, Berkelium, Californium, Einsteinium, Fermium, Mendelevium, and Nobelium, the method comprising contacting a liquid composition including the element with the polymer of Aspect 1 to form an element-polymer adduct.

Aspect 18. The method of Aspect 17 wherein the element is selected from the group consisting of Scandium (Sc), Yttrium (Y), Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium (Th), Ytterbium (Yb), Lutetium (Lu) and combinations thereof.

Aspect 19. The method of Aspect 17 or 18 wherein the element is a cation of an element.

Aspect 20. The method of any one of Aspects 17-19 wherein element is selected from the group consisting of Lu, Er, Ho, Dy, Tb, Eu, Gd, Sm and combinations thereof.

Aspect 21. The method of any one of Aspects 17-20 wherein the element is Lu.

Aspect 22. The method of any one of Aspects 17-21 wherein the element is selected from the group consisting of Nd, Pr, Ce, La and combinations thereof.

Aspect 23. The method of any one of Aspects 17-22 wherein the pH of the liquid composition is from about 1 to about 6.

Aspect 24. The method of any one of Aspects 17-23 wherein the pH of the liquid composition is from about 2 to about 6.

Aspect 25. The method of any one of Aspects 17-24 wherein the pH of the liquid composition is from about 3 to about 6.

Aspect 26. The method of any one of Aspects 17-25 wherein the pH of the liquid composition is from about 4 to about 6.

Aspect 27. The method of any one of Aspects 17-26 wherein the pH of the liquid composition is from about 5 to about 6.

Aspect 28. The method of any one of Aspects 17-27 wherein the contacting includes eluting the liquid composition through a column including the polymer.

Aspect 29. The method of any one of Aspects 17-28 wherein an element concentration in the liquid composition is from about 1 ppm to about 10000 ppm, or from 1 ppm to about 1000 ppm, or from about 1 ppm to about 100 ppm, or from about 1 ppm to about 10 ppm, or from about 10 ppm to about 100 ppm, or from about 100 ppm to about 1000 ppm, or from about 1000 ppm to about 10000 ppm, or from about 1 ppm to about 50 ppm, or from about 1 ppm to about 200 ppm, or from about 1 ppm to about 500 ppm, or from about 1 ppm to about 2000 ppm, or from about 1 ppm to about 5000 ppm.

Aspect 30. The method of any one of Aspects 17-28 wherein an element or REE concentration in the liquid composition is from about 1 ppb to about 1000 ppb, or from 1 ppb to about 1000 ppb, or from about 1 ppb to about 100 ppb, or from about 1 ppb to about 10 ppb, or from about 10 ppb to about 100 ppb, or from about 100 ppb to about 1000 ppb, or from about 1000 ppb to about 10000 ppb, or from about 1 ppb to about 50 ppb, or from about 1 ppb to about 200 ppb, or from about 1 ppb to about 500 ppb, or from about 1 ppb to about 2000 ppb, or from about 1 ppb to about 5000 ppb.

Aspect 31. The method of any one of Aspects 17-30 wherein the REE is separated from the element-polymer adduct.

Aspect 32. The method of any one of Aspects 17-31 wherein the element-polymer adduct is treated with an acidic aqueous solution sufficient to desorb the element from the element-polymer adduct and/or with a composition including a small molecule chelator.

Aspect 33. The method of any one of Aspects 17-32 wherein the pH of the aqueous solution is from about 0 to about 5.

Aspect 34. The method of any one of Aspects 17-33 wherein the pH of the aqueous solution is from about 1 to about 3.

Aspect 35. The method of any one of Aspects 17-34 wherein from about 10% to about 100% of the element in the liquid composition is separated from the liquid composition.

Aspect 36. The method of any one of Aspects 17-35 wherein from about 20% to about 100% of the element in the liquid composition is separated from the liquid composition.

Aspect 37. The method of any one of Aspects 17-36 wherein from about 30% to about 100% of the element in the liquid composition is separated from the liquid composition.

Aspect 38. The method of any one of Aspects 17-37 wherein from about 40% to about 100% of the element in the liquid composition is separated from the liquid composition.

Aspect 39. The method of any one of Aspects 17-38 wherein from about 50% to about 100% of the element in the liquid composition is separated from the liquid composition.

Aspect 40. The method of any one of Aspects 17-39 wherein from about 60% to about 100% of the element in the liquid composition is separated from the liquid composition.

Aspect 41. The method of any one of Aspects 17-40 wherein from about 70% to about 100% of the element in the liquid composition is separated from the liquid composition.

Aspect 42. The method of any one of Aspects 17-41 wherein from about 80% to about 100% of the element in the liquid composition is separated from the liquid composition.

Aspect 43. The method of any one of Aspects 17-42 wherein from about 90% to about 100% of the element in the liquid composition is separated from the liquid composition.

Aspect 44. A polymer including the free bases and/or acid addition salts of a cross-linked copolymerization product of (a) a polyethylenepolyamine containing from about two to about 10 ethylene units and (b) a second member selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane, wherein the product contains by weight from about 10 percent to about 50 percent of said second member; and wherein the polymer includes a multiplicity of —C(R₁R₂P(O)(OH)₂ moieties, or salts thereof, wherein the carbon atoms of the —C(R₁R₂P(O)(OH)₂ moieties are covalently bonded to nitrogens, wherein R₁ and R₂ are independently H, C₁-C₆ alkyl, or C₈-C₁₂ aryl Aspect 45. The polymer of Aspect 44 wherein the polyethylenepolyamine is diethylenetriamine.

Aspect 46. The polymer of Aspect 44 or Aspect 45 wherein the polyethylenepolyamine is triethylenetetraamine.

Aspect 47. The polymer of any one of Aspects 44-46 wherein the polyethylenepolyamine is tetraethylenepentaamine.

Aspect 48. The polymer of any one of Aspects 44-47 wherein R₁ is H.

Aspect 49. The polymer of any one of Aspects 44-48 wherein R₂ is H.

Aspect The polymer of any one of Aspects 44-49 wherein R₁ and R₂ are H.

Aspect 51. The polymer of any one of Aspects 44-50 wherein R₁ is CH₃.

Aspect 52. The polymer of any one of Aspects 44-51 wherein R₂ is CH₃.

Aspect 53. The polymer of any one of Aspects 44-52 wherein R₁ is CH₂CH₃.

Aspect 54. The polymer of any one of Aspects 44-53 wherein R₂ is CH₂CH₃.

Aspect 55. The polymer of any one of Aspects 44-54 wherein the second member is epichlorohydrin.

Aspect 56. The polymer of any one of Aspects 44-55 wherein the second member is 1,3-dichloro-2-propanol.

Aspect 57. The polymer of any one of Aspects 44-56 wherein the second member is diepoxybutane.

Aspect 58. The polymer of any one of Aspects 44-57 wherein the amount of phosphorous in the polymer by weight is from about 5% to about 30%.

Aspect 59. The polymer of any one of Aspects 44-58 wherein the amount of phosphorous in the polymer by weight is from about 5% to about 20%.

Aspect 60. The polymer of any one of Aspects 44-59 wherein the amount of phosphorous in the polymer by weight is from about 5% to about 15%, or from about 8% to about 15%, or from about 10% to 15%.

Aspect 61. A method of isolating an element selected from the group consisting of Lithium, Lead, Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Lutetium, Hafnium, Tantalum, Tungsten, Rhenium, Osmium, Iridium, Platinum, Gold, Mercury, Lanthanum, Cerium, Praseodymium, Neodymium, Promethium, Samarium, Europium, Gadolinium, Terbium, Dysprosium, Holmium, Erbium, Thulium, Ytterbium, Lutetium, Lawrencium, Rutherfordium, Dubnium, Seaborgium, Bohrium, Hassium, Meitnerium, Darmstadtium, Roentgenium, Copernicium, Actinium, Thorium, Protactinium, Uranium, Neptunium, Plutonium, Americium, Curium, Berkelium, Californium, Einsteinium, Fermium, Mendelevium, and Nobelium, the method including contacting a liquid composition including the element with the polymer of Aspect 43 to form an element-polymer adduct.

Aspect 62. The method of Aspect 61 wherein the element is selected from the group consisting of Scandium (Sc), Yttrium (Y), Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium (Th), Ytterbium (Yb), Lutetium (Lu) and combinations thereof.

Aspect 63. The method of Aspect 61 or 62 wherein the element is a cation of an element.

Aspect 64. The method of any one of Aspects 61-63 wherein the element is selected from the group consisting of Lu, Er, Ho, Dy, Tb, Eu, Gd, Sm and combinations thereof.

Aspect 65. The method of any one of Aspects 61-64 wherein the element is Lu.

Aspect 66. The method of any one of Aspects 61-65 wherein the element is selected from the group consisting of Nd, Pr, Ce, La and combinations thereof.

Aspect The method of any one of Aspects 61-66 wherein the pH of the liquid composition is from about 1 to about 6.

Aspect 68. The method of any one of Aspects 61-67 wherein the pH of the liquid composition is from about 2 to about 6.

Aspect 69. The method of any one of Aspects 61-68 wherein the pH of the liquid composition is from about 3 to about 6.

Aspect 70. The method of any one of Aspects 61-69 wherein the pH of the liquid composition is from about 4 to about 6.

Aspect 71. The method of any one of Aspects 61-70 wherein the pH of the liquid composition is from about 5 to about 6.

Aspect 72. The method of any one of Aspects 61-71 wherein the contacting includes eluting the liquid composition through a column including the polymer.

Aspect 73. The method of any one of Aspects 61-72 wherein an element concentration in the liquid composition is from about 1 ppm to about 10000 ppm.

Aspect 74. The method of any one of Aspects 61-73 wherein an element concentration in the liquid composition is from about 1 ppb to about 1000 ppb, Aspect 75. The method of any one of Aspects 61-74 wherein the element is separated from the element-polymer adduct.

Aspect 76. The method of any one of Aspects 61-75 wherein the element-polymer adduct is treated with an acidic aqueous solution sufficient to desorb the element from the element-polymer adduct.

Aspect 77. The method of any one of Aspects 61-76 wherein the pH of the aqueous solution is from about 0 to about 5.

Aspect 78. The method of any one of Aspects 61-77 wherein the pH of the aqueous solution is from about 1 to about 3.

Aspect 79. The method of any one of Aspects 61-78 wherein from about 10% to about 100% of the element in the liquid composition is separated from the liquid composition.

Aspect 80. The method of any one of Aspects 61-79 wherein from about 20% to about 100% of the element in the liquid composition is separated from the liquid composition.

Aspect 81. The method of any one of Aspects 61-80 wherein from about 30% to about 100% of the element in the liquid composition is separated from the liquid composition.

Aspect 82. The method of any one of Aspects 61-81 wherein from about 40% to about 100% of the element in the liquid composition is separated from the liquid composition.

Aspect 83. The method of any one of Aspects 61-82 wherein from about 50% to about 100% of the element in the liquid composition is separated from the liquid composition.

Aspect 84. The method of any one of Aspects 61-83 wherein from about 60% to about 100% of the element in the liquid composition is separated from the liquid composition.

Aspect 85. The method of any one of Aspects 61-84 wherein from about 70% to about 100% of the element in the liquid composition is separated from the liquid composition.

Aspect 86. The method of any one of Aspects 61-85 wherein from about 80% to about 100% of the element in the liquid composition is separated from the liquid composition.

Aspect 87. The method of any one of Aspects 61-86 wherein from about 90% to about 100% of the element in the liquid composition is separated from the liquid composition.

Aspect 88. The method of Aspect 17 or Aspect 61 wherein the liquid composition includes a coal ash, a coal ash extract, coal ash digestate, a fly ash, a fly ash extract, and/or a fly ash digestate.

Aspect 89. The method of Aspect 17 or Aspect 61 wherein the liquid composition includes a bauxite residue, a bauxite residue extract, and/or a bauxite digestate.

Aspect 90. The method of Aspect 17 or Aspect 61 wherein the liquid composition includes an electronics waste stream, an electronics residue extract, and/or a electronics residue digestate.

Aspect 91. The use of a polymer of Aspect 1 or Aspect 44 to separate an element from a liquid composition.

Aspect 92. A method of preparing a polymer including the free bases and/or acid addition salts of a cross-linked copolymerization product of (a) a polyethylenepolyamine containing from about two to about 10 ethylene units and (b) a second member selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane, wherein the product contains by weight from about 10 percent to about 50 percent of said second member; and wherein the polymer includes a multiplicity of —C(R₁R₂P(O)(OH)₂ moieties, or salts thereof, wherein the carbon atoms of the —C(R₁R₂P(O)(OH)₂ moieties are covalently bonded to nitrogens, the method including: reacting a polyethylenepolyamine containing from about two to about 10 ethylene units and a compound selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane to produce an intermediate; and reacting the intermediate with a compound of formula R₁R₂CO, or an acetal or hemiacetal thereof, phosphonic acid and/or phosphoric acid, wherein R₁ and R₂ are independently H, C₁-C₆ alkyl, or C₆-C₁₂ aryl.

Aspect 93. The method of aspect 32 wherein the small molecule chelator is selected from the group consisting of an aminocarboxylic acid, an aminocarboxylic acid salt, citric acid, a citric acid salt, an alpha-hydroxy carboxylic acid, an alpha-hydroxy carboxylic acid salt, an amino acid, and an amino acid salt.

Aspect 94. The polymer of aspect 44 wherein the number of ethylene units is selected from the group consisting of 2, 3, 4, 5, 6, 7, 8, 9, 10, and a combination thereof.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Phosphorous acid and lanthanide chloride salts (trace metals grade) were purchased from SIGMA-ALDRICH®. Diethylene triamine (DETA), formalin (37% aqueous solution), and epichlorohydrin were purchased from OAKWOOD CHEMICAL™. Concentrated HCl (aq) and HNO₃ (aq) were purchased from FISHER SCIENTIFIC®. A coal ash sample was generously donated by APPALACHIAN POWER® (John E. Amos Power Plant, Charleston, WV). For the water-soluble polymer analog studies, linear PEI-MP was synthesized and used as previously reported in Archer, W. R.; Fiorito, A.; Heinz-Kunert, S. L.; MacNicol, P. L.; Winn, S. A.; Schulz, M. D. Synthesis and Rare-Earth-Element Chelation Properties of Linear Poly(ethylenimine methylenephosphonate). Macromolecules 2020, 53 (6), 2061-2068.

ICP-MS was collected using a Thermo Electron iCAP-RQ inductively coupled plasma mass spectrometer (ICP-MS) per Standard Method 3125-B (APHA, AWWA, and WEF, 1998). See APHA; AWWA; WEF, Standard Methods for Examination of Water and Wastewater. 20 ed.; 1998. Samples and calibration standards were prepared in a matrix of 2% nitric acid by volume.

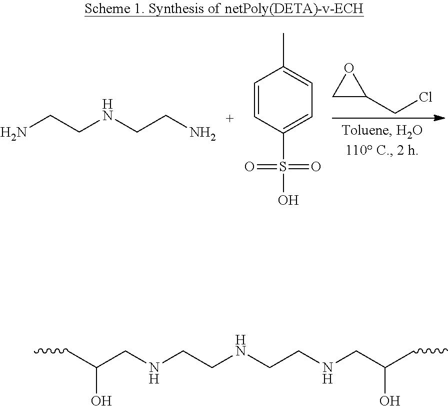

Synthesis of net-Poly(diethylenetriamine)-ν-epichlorohydrin methylenephosphonate (netPoly(DETA)-ν-ECH MP) as depicted in Scheme 1. With reference to Scheme 1, diethylenetriamine (20.4 mmol, 1.0 equiv.) and para-toluenesulfonic acid (0.40 mmol, 0.02 equiv.) were combined in a 500 mL round bottom flask with distilled water (90 mL) and toluene (400 mL). After stirring for 15 min, epichlorohydrin (50.9 mmol, 2.5 equiv.) was added dropwise and the reaction mixture stirred while refluxing for 1 h after which time the solution turned yellow. The solution was filtered and the solid (polymer resin) was dried in a vacuum oven at 100′C overnight to afford a yellow solid. Combustion analysis was consistent with the assigned structure for netPoly(DETA)-ν-ECH (Table 1).

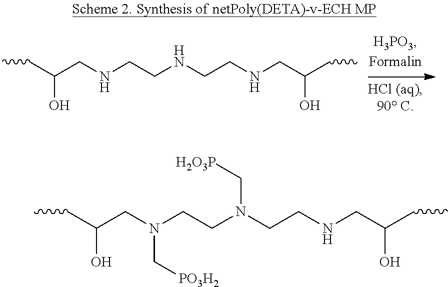

With reference to Scheme 2, phosporous acid (H₃PO₃) (5.2 mmol, 1.0 equiv.), and netPoly(DETA)-ν-ECH (9.3 mmol, 1.0 equiv.) were combined with concentrated HCl (1 mL) and distilled water (10 mL) in a 25 mL round bottom flask with a mag-netic stir bar and heated to 90° C. Formalin (18.5 mmol, 5.0 equiv.) was added dropwise over the course of 1 h and the mixture was refluxed at 90° C. After 24 h, additional formalin (18.5 mmol, 4.0 equiv.) was added dropwise over 20 min and continued to reflux for 24 h. The reaction mixture was cooled to room temperature and filtered. The functionalized polymer resin product was washed with isopropanol, ethanol, and distilled water and was dried overnight. Combustion analysis was consistent with the assigned generalized structure for netPoly(DETA)-ν-ECH MP (Table 1).

TABLE 1
Experimental combustion analysis results for netPoly(DETA)-
v-ECH and netPoly(DETA)-v-ECH MP.

| | Experimental Composition (%) | Experimental Composition (%) |
|---|---|---|
| | netPoly(DETA)-v-ECH | netPoly(DETA)-v-ECH MP |
| % C | 40.1 | 31.1 |
| % H | 8.2 | 6.7 |
| % N | 12.7 | 8.3 |
| % P | N/A | 10.4 |
| C/N | 3.2 | 3.7 |
| P/N | N/A | 1.2 |

The IR spectrum of the polymer resin exhibited characteristic bands at 1349-1498 cm⁻¹ (C—N), and 2906-3648 cm⁻¹ (—OH). These bands persisted in the functionalized polymer resin; however, additional absorption bands were observed in the ranges of 852-954 cm⁻¹ (P—O), and 1103-1263 cm⁻¹ (P═O) for the functionalized polymer resin that agreed with previously published IR spectra of similar phosphonate-containing molecules. Furthermore, as summarized in Table 2, energy dispersive X-ray spectroscopy (EDS) of the functionalized polymer resin confirmed the presence of P and N on the functionalized resin surface,

TABLE 2
Experimental energy dispersive X-ray spectroscopy results for
netPoly(DETA)-v-ECH and netPoly(DETA)-v-ECH MP.

| %Element | | |
|---|---|---|
| detected on | | |
| resin surface | netPoly(DETA)-v-ECH | netPoly(DETA)-v-ECH MP |
| % C | 53.1 | 47.7 |
| % N | 9.9 | 11.6 |
| % P | N/A | 10.0 |
| % O | 7.4 | 21.0 |
| % Cl | 29.6 | 9.7 |

Effect of solution pH on REE Removal The effect of pH on REE extraction was examined by varying the solution pH (pHs 1-6). Insoluble lanthanide hydroxides form above pH 6, precluding testing at higher pH. To mimic the dilute concentrations of REE-containing aqueous coal mine drainage, five 5 mL fractions of representative REEs (approximately 19 ppb of each REE, 115 ppb total REE: Pr (III), Nd (III), Gd (III), Ho (III) Er (III), and Lu (III)) were flowed over 50 mg of the functionalized resin and collected the resulting fractions. The amount of REE absorbed onto the resin (qᵢ) was calculated according to Equation 1, where Co is the initial concentration of REEs, C_{f} is the REE concentration in the liquid phase after flowing through the resin, and C_{A} is the mass of the resin.

$${q}_{t} = \frac{{C}_{0} - {C}_{f}}{{C}_{A}} \qquad Equation 1$$

As shown in FIG. 1, REE sorption was highest at pH 6 (approximately 0.07 pg REE per mg resin), and lowest at more acidic pHs (<0.02 pg REE per mg resin. This result suggests that the protonation state of the resin plays an important role in REE binding. Each phosphonic acid group contains two acidic protons: pKₐ 1.1-2.3 and pKₐ is 5.3-7.2. Thus, when the phosphonic acid is mostly deprotonated (above pH 5), the oxygens are available to ionically interact with the REEs; however, at pH<5, the phosphonic acids and the nitrogens in the resin backbone become protonated, significantly reducing their ability to bind REEs.

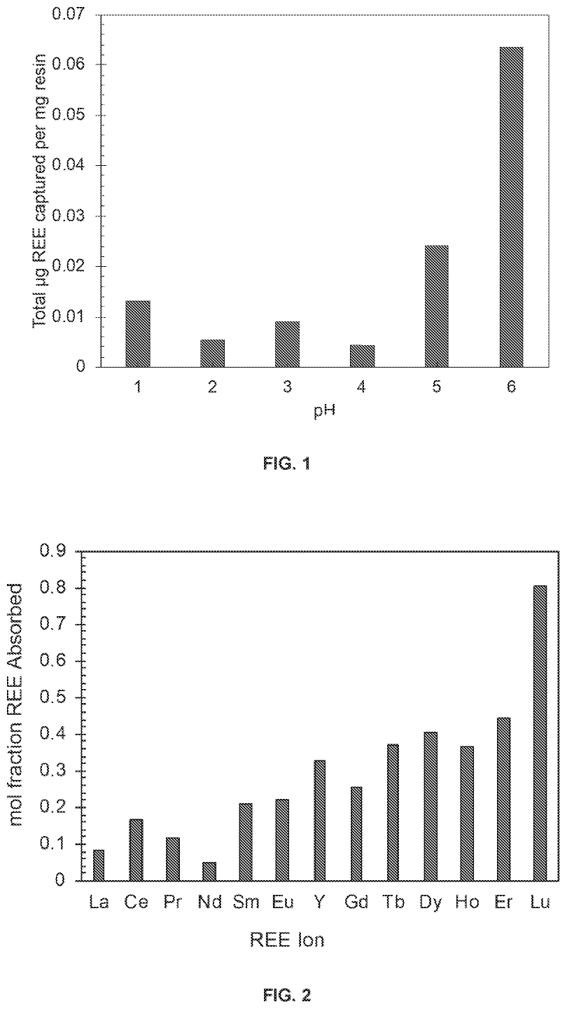

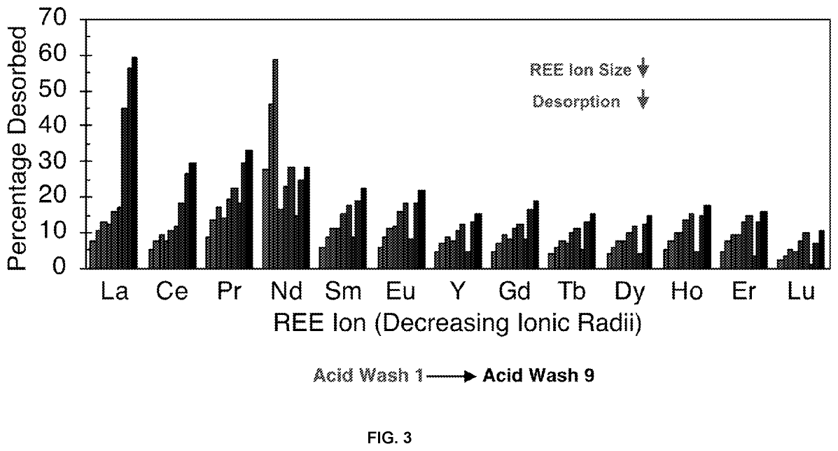

Effect of REE Identity on Sorption: To examine the effect of REE identity on functionalized polymer resin capture, a solution of REEs (approximately 5 ppm each REE, 13 REEs total, pH 6) was flowed over the functionalized polymer resin and collected a series of fractions for analysis by ICP-MS. After adding 15 mL (3×5 mL) of the REE solution, 3 mL of 0.5 M HNO₃ was passed over the same resin to desorb the bound REEs. The mol fraction of REEs captured by the resin was highest for the heavy lanthanides. See FIG. 2.

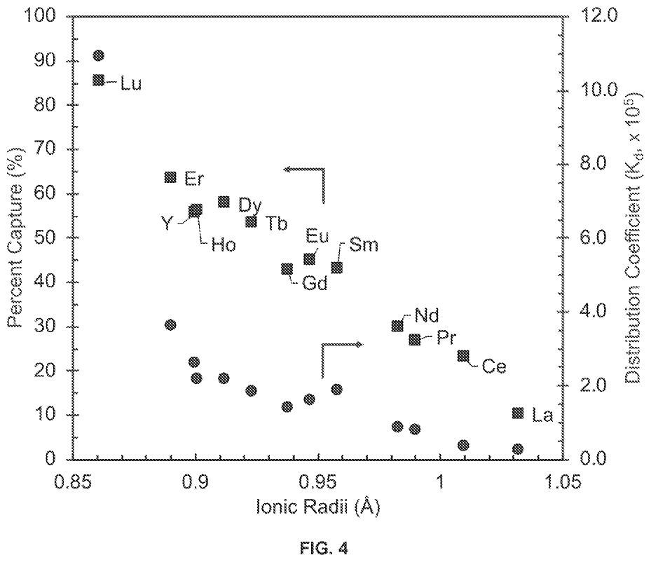

Typically, ligand coordination to the lanthanide ions in solution relies heavily on the concentration of both the ligands and REE ion. However, for the resins described herein, the phosphonate ligands are immobilized by the resin, thus the number of ligands coordinating to the REE cannot change. Therefore, only those REE ions which have an appropriate radius for the bite angle of the ligand are retained by the resin. Furthermore, previous research indicates that, in solution, REE-polymer binding is driven by ΔS, resulting from the release of complexed water molecules during binding. Interestingly, ΔH_{Hydr} also decreases with increasing atomic number for the lanthanide series. Not wishing to be bound by any particular theory, it is believed that in addition to variations in ionic radii, the decrease in the number of coordinated water molecules and ΔH_{Hydr} also produces this difference in REE selectivity. The opposite trend was observed when 0.5 M HNO₃ was passed over the resin; the larger REE ions detached from the resin more readily, resulting in a greater desorption for these ions. The distribution coefficient, K_{d}, which describes the affinity and selectivity for the resin for each REE and was calculated according to Equation 2.

$${K}_{d} = \frac{V}{m} \times \frac{( {C}_{0} - {C}_{f} )}{{C}_{f}} \qquad Equation 2$$

wherein V, m, C₀, and C_{f} are the volume of the solution, mass of REE, and the initial and final concentrations, respectively. There is a correlation between the REE ionic radii and the percent capture for each REE and the calculated distribution coefficient in the resin flow experiment. See FIG. 4.

As opposed to materials functionalized only on the surface, the functionalized polymer resin was found to comprise chelating functional groups throughout the bulk of the material (i.e., this resin is porous and swellable, enabling access to chelation sites throughout the material) and therefore a higher sorption capacity. Not wishing to be bound by any particular theory or mode of operation, it is believed the resins described herein would therefore exhibit a higher REE sorption capacity compared to surface-functionalized materials. To evaluate the REE sorption capacity of resins described herein, a bulk sorption experiment was performed where the resin (˜100 mg) was placed in an REE stock solution (22 or 45 ppm total REE) and allowed to stir for 72 h. After 72 h, REE sorption was determined by inductively coupled plasma mass spectroscopy (ICP-MS). Based on this experiment, the absorption capacity of the phosphonated resin was 64 mg of REE per g of resin in a 22 ppm REE solution, and 76 mg REE per g of resin in a 45 ppm REE solution.

Batch and flow experiments were used to calculate separation factors (SFs) for this material as a function of REE identity. SFs were calculated as Dₘₑₜₐₗ₂/Dₘₑₜₐₗ₁ where D=[REE]_{TF}/[REE]_{T0}. SFs near 1 suggest an equal preference for ion absorption, while SFs much greater (or less) than 1 indicate a partiality for a particular ion over another, In the batch experiments described earlier, the resin captured approximately the same concentration of each REE after 72 h, resulting in nearly identical SFs for each REE (between 0.96-1.05). However, sorption selectivity among the REEs was achieved in the flow experiments. In this case, SFs confirmed a high preference for this material to chelate the heavier REEs: SFs varied between 0.8-7.9. In contrast to the flow experiments, batch experiments provided information on chemical equilibrium of the REE-resin interaction over a time period. Table 3 below discloses the numerical data.

TABLE 3
Separation Factors for net Poly(DETA)-ν-ECH MP

| | | | | | | | | | | | | |
|---|---|---|---|---|---|---|---|---|---|---|---|---|
| SF | Ce | Pr | Nd | Sm | Eu | Y | Gd | Tb | Dy | Ho | Er | Lu |

72 h. Batch Experiment

| | | | | | | | | | | | | |
|---|---|---|---|---|---|---|---|---|---|---|---|---|
| La | 0.96 | 0.99 | 0.98 | 0.97 | 0.96 | 0.98 | 0.97 | 1.00 | 0.97 | 1.00 | 0.97 | 0.99 |
| Ce | | 1.04 | 1.02 | 1.01 | 1.01 | 1.03 | 1.02 | 1.04 | 1.02 | 1.05 | 1.02 | 1.04 |
| Pr | | | 0.99 | 0.97 | 0.97 | 0.99 | 0.98 | 1.01 | 0.98 | 1.01 | 0.98 | 1.00 |
| Nd | | | | 0.99 | 0.99 | 1.00 | 1.00 | 1.02 | 0.99 | 1.03 | 1.00 | 1.02 |
| Sm | | | | | 1.00 | 1.02 | 1.01 | 1.03 | 1.01 | 1.04 | 1.01 | 1.03 |
| Eu | | | | | | 1.02 | 1.01 | 1.03 | 1.01 | 1.04 | 1.01 | 1.03 |
| Y | | | | | | | 0.99 | 1.02 | 0.99 | 1.02 | 0.99 | 1.01 |
| Gd | | | | | | | | 1.02 | 1.00 | 1.03 | 1.00 | 1.02 |
| Tb | | | | | | | | | 0.97 | 1.01 | 0.97 | 1.00 |
| Dy | | | | | | | | | | 1.03 | 1.00 | 1.02 |
| Ho | | | | | | | | | | | 0.97 | 0.99 |
| Er | | | | | | | | | | | | 1.02 |

Flow Experiment

| | | | | | | | | | | | | |
|---|---|---|---|---|---|---|---|---|---|---|---|---|
| La | 2.24 | 2.29 | 2.47 | 3.74 | 3.89 | 4.86 | 3.90 | 5.02 | 5.39 | 5.02 | 5.67 | 7.94 |
| Ce | | 1.02 | 1.10 | 1.67 | 1.74 | 2.17 | 1.74 | 2.24 | 2.41 | 2.24 | 2.53 | 3.55 |
| Pr | | | 1.08 | 1.64 | 1.70 | 2.12 | 1.71 | 2.20 | 2.36 | 2.20 | 2.48 | 3.47 |
| Nd | | | | 1.51 | 1.58 | 1.97 | 1.58 | 2.03 | 2.18 | 2.03 | 2.30 | 3.21 |
| Sm | | | | | 1.04 | 1.30 | 1.04 | 1.34 | 1.44 | 1.34 | 1.52 | 2.12 |
| Eu | | | | | | 1.25 | 1.00 | 1.29 | 1.39 | 1.29 | 1.46 | 2.04 |
| Y | | | | | | | 0.80 | 1.03 | 1.11 | 1.03 | 1.17 | 1.63 |
| Gd | | | | | | | | 1.29 | 1.38 | 1.29 | 1.45 | 2.03 |
| Tb | | | | | | | | | 1.07 | 1.00 | 1.13 | 1.58 |
| Dy | | | | | | | | | | 0.93 | 1.05 | 1.47 |
| Ho | | | | | | | | | | | 1.13 | 1.58 |
| Er | | | | | | | | | | | | 1.40 |

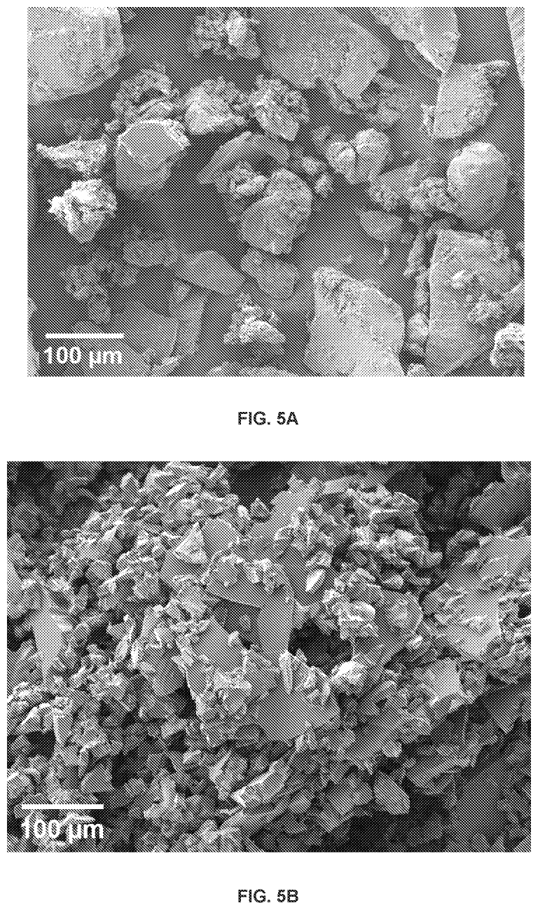

Electron microscopy (SEM) was used to characterize the particle morphology of the polymer resin. SEM analysis of the unfunctionalized resin revealed particle sizes that were 80±22 μm in diameter (FIG. 5A). Upon functionalization with methyl phosphonate groups, the average particle size was 64±27 pm (FIG. 5B). After flowing the metal solution over the polymer resin, the average particle size was approximately 84±6 pm (FIG. 5C). Overall, the particle sizes remained consistent (within error) throughout these processes.

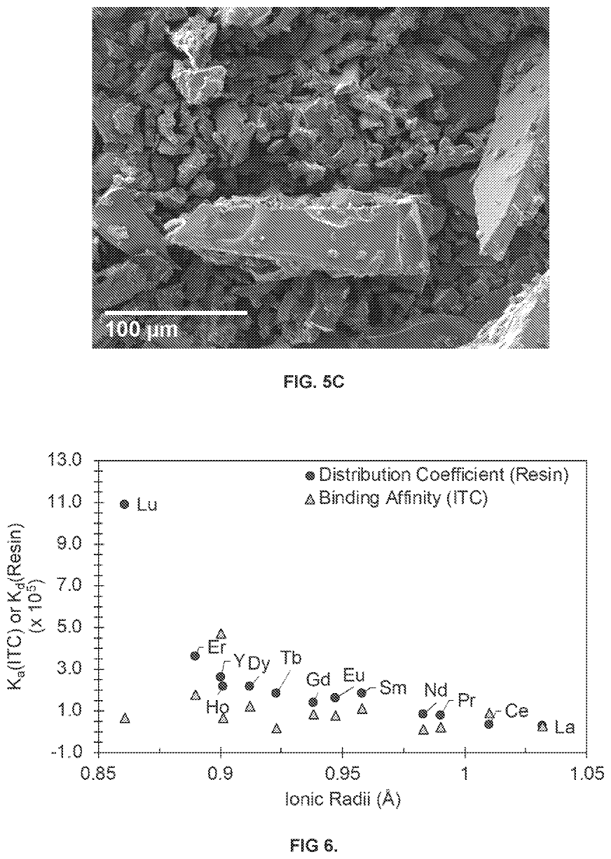

Due to their similar structure, PEI-MP was used as a soluble analogue of netPoly(DETA)-ν-ECH MP, and measured the binding affinity (Kₐ) of PEI-MP to the entire REE series using Isothermal Titration Calorimetry (ITC). Across the series of REEs, the Kₐ obtained from the ITC experiments (K_{a(ITC)}) correlated well with the distribution coefficients (K_{d(Flow)}) (See Equation 2) calculated in the previous flow experiments. With the exception of Lu, K_{a(ITC)} and K_{d(Flow)} followed similar trends for each REE. See FIG. 6. The high selectivity of the resin for Lu is not fully understood, but the difference between the K_{a(ITC)} and K_{d(Flow)} suggests that the selectivity arises from conformational differences in the chelating sites: In the solution calorimetry experiments, the polymer chains have greater conformational freedom than the relatively rigid chelating sites of the solid-phase crosslinked network. A second possibility is that the small ionic radius of Lu (the smallest of the REEs) enables the Lu ions to penetrate the polymer network more rapidly than the other REE ions, resulting in higher uptake in the flow experiment.

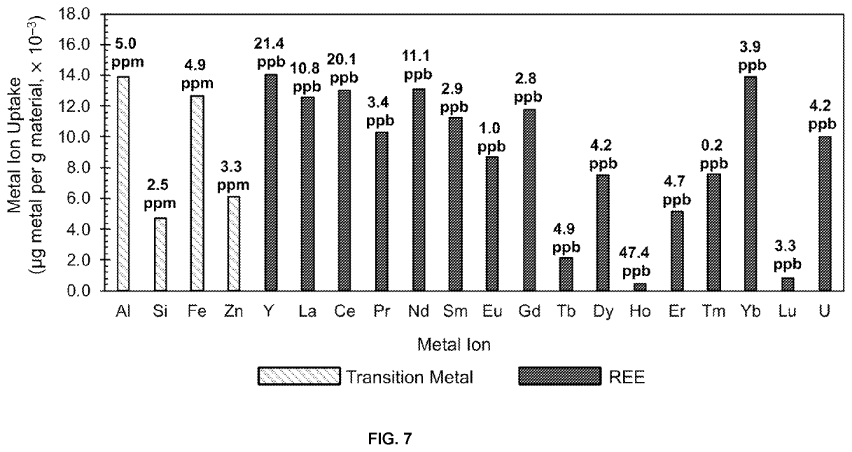

Coal Ash Extraction: Metal ions were leached from a coal ash sample into solution, and the resin's selectivity was examined for each metal ion. Three grams of a coal ash sample was dissolved in 100 mL of concentrated HNO₃ and allowed to stir for 24 hours at room temperature. After the 24 hours, the undigested coal ash was removed by filtration and the filtrate was evaporated to provide an off-white solid. In this digested sample of coal ash, the concentration of several transition metals (e.g., Al, Fe, Zn, Si, Ni, Cr, and Cu) accounted for over 99% of the total metal ions. The concentration of these transition metal ions varied between 400-13,000 ppm per g of coal ash (14-5,000 ppb in the initial leach solution), while the concentration of REEs for this sample was below 10 ppb for each REE. The netPoly(DETA)-ν-ECH MP successfully extracted several REEs from these dilute conditions; however, many of the di- and trivalent transition metals (in concentration approximately 125 times greater than the REEs) were also retained by the polymer resin See FIG. 7. These findings suggest that the material reported here may be more suitable for downstream applications in the REE refinement process, e.g., removing the REE after removal of more concentrated metal ions.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A network polymer comprising a unit of formula (I): 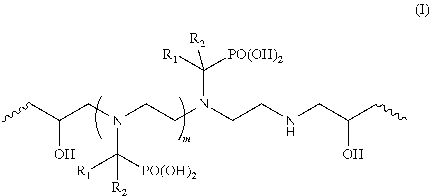
wherein m is an integer from 1 to 4;
R₁ and R₂ are independently H, D, C₁-C₆ alkyl, or C₆-C₁₂ aryl,;
or a salt thereof.

2. The polymer of claim 1 wherein m is 1, 2, or 3.

3. (canceled)

4. (canceled)

5. The polymer of claim 1 wherein R₁ is H.

6. The polymer of claim 1 wherein R₂ is H.

7. (canceled)

8. The polymer of claim 1 wherein R₁ is CH₃.

9. The polymer of claim 1 wherein R₂ is CH₃.

10. The polymer of claim 1 wherein R₁ is CH₂CH₃.

11. The polymer of claim 1 wherein R₂ is CH₂CH₃.

12. (canceled)

13. (canceled)

14. (canceled)

15. (canceled)

16. (canceled)

17. A method of isolating an element selected from the group consisting of Lithium, Lead, Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Lutetium, Hafnium, Tantalum, Tungsten, Rhenium, Osmium, Iridium, Platinum, Gold, Mercury, Lanthanum, Cerium, Praseodymium, Neodymium, Promethium, Samarium, Europium, Gadolinium, Terbium, Dysprosium, Holmium, Erbium, Thulium, Ytterbium, Lutetium, Lawrencium, Rutherfordium, Dubnium, Seaborgium, Bohrium, Hassium, Meitnerium, Darmstadtium, Roentgenium, Copernicium, Actinium, Thorium, Protactinium, Uranium, Neptunium, Plutonium, Americium, Curium, Berkelium, Californium, Einsteinium, Fermium, Mendelevium, and Nobelium, the method comprising contacting a liquid composition comprising the element with the polymer of claim 1 to form an element-polymer adduct.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. A polymer comprising the free bases and/or acid addition salts of a cross-linked copolymerization product of (a) a polyethylenepolyamine containing from about two to about 10 ethylene units and (b) a second member selected from the group consisting of epichlorohydrin, 1,3-dichloro-2-propanol, diepoxybutane, bis-(2,3-epoxy)propyl ether, ethylene glycol bis-(2,3-epoxy)propyl ether, 1,4-butanediol bis-(2,3-epoxy)propyl ether, 1,3-dibromopropane, 1,3-dichloropropane, 1,4-dibrombutane, and 1,4-dichlorobutane, wherein the product contains by weight from about 10 percent to about 50 percent of said second member; and wherein the polymer comprises a multiplicity of —C(R₁R₂P(O)(OH)₂ moieties, or salts thereof, wherein the carbon atoms of the —C(R₁R₂P(O)(OH)₂ moieties are covalently bonded to nitrogens, wherein R₁ and R₂ are independently H, C₁-C₆ alkyl, or C₆-C₁₂ aryl.

45. The polymer of claim 44 wherein the polyethylenepolyamine is selected from the group consisting of diethylenetriamine, triethylenetetramine, and tetraethylenepentaamine.

46. (canceled)

47. (canceled)

48. The polymer of claim 44 wherein R₁ is H.

49. The polymer of claim 44 wherein R₂ is H.

50. (canceled)

51. The polymer of claim 44 wherein R₁ is CH₃.

52. The polymer of claim 44 wherein R₂ is CH₃.

53. The polymer of claim 44 wherein R₁ is CH₂CH₃.

54. The polymer of claim 44 wherein R₂ is CH₂CH₃.

55. The polymer of claim 44 wherein the second member is selected from the group consisting of epichlorohydrin, 1,3-dichloro-2-propanol, and diepoxybutane.

56. (canceled)

57. (canceled)

58. The polymer of claim 44 wherein the amount of phosphorous in the polymer by weight is from about 5% to about 30%.

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)
